(19) United States
(12) Patent Application Publication
(10) Pub. No.: US 2019/0333446 A1
(43) Pub. Date: Oct. 31, 2019

(54) PIXEL DRIVING CIRCUIT AND DRIVING METHOD THEREOF DISPLAY PANEL AND DISPLAY APPARATUS

(71) Applicant: BOE Technology Group Co., Ltd., Beijing (CN)

(72) Inventor: Xinshe Yin, Beijing (CN)

(21) Appl. No.: 16/197,936

(22) Filed: Nov. 21, 2018

(30) Foreign Application Priority Data
Apr. 28, 2018 (CN) 201810407968.4

(51) Int. Cl. G09G 3/3233

(52) U.S. Cl. CPC G09G 3/3233; G09G 2300/0819

(57) ABSTRACT

The present application relates to a pixel driving circuit and a driving method thereof, a display panel, and a display apparatus. The pixel driving circuit includes: a driving sub-circuit; a charging sub-circuit electrically connected to a first power supply line, a first control signal line, and the driving sub-circuit, and configured to provide a first voltage signal to the driving sub-circuit under control of a first control signal; a writing compensation sub-circuit electrically connected to a reference signal line, a data signal line, a scanning signal line, and the driving sub-circuit, and configured to provide a reference voltage signal and a data signal to the driving sub-circuit under control of a scanning signal; and a light emitting control sub-circuit electrically connected to the first power supply line, a second control signal line, the driving sub-circuit and a first terminal of a light emitting element, and configured to provide current for causing the light emitting element to emit light to the light emitting element under control of a second control signal.

### CROSS-REFERENCE TO RELATED APPLICATION(S)

This application claims priority to the Chinese Patent Application No. 201810407968.4, filed on Apr. 28, 2018, which is incorporated herein by reference in its entirety.

### TECHNICAL FIELD

The present disclosure relates to the field of display technology, and more particularly, to a pixel driving circuit and a driving method thereof, a display panel, and a display apparatus.

### BACKGROUND

Recently, researches on Organic Light Emitting Diode (OLED) displays are hot in the field of flat panel displays.

Unlike a Thin Film Transistor-Liquid Crystal Display (TFT-LCD), which control brightness using a stable voltage, an OLED display is driven by current and requires constant current supply so that it can provide stable light emission. A pixel driving circuit of an OLED display panel comprises a driving transistor. When a row where pixel units are located is gated, a switch transistor electrically connected to the driving transistor is turned on, and a data voltage is applied to the driving transistor via the switch transistor, so that the driving transistor outputs current corresponding to the data voltage to an OLED element, thereby driving the OLED element to emit light of corresponding brightness.

### SUMMARY

The present disclosure proposes a pixel driving circuit and a driving method thereof, a display panel, and a display apparatus.

According to an aspect of the present disclosure, there is proposed a pixel driving circuit configured to drive a light emitting element to emit light, the pixel driving circuit comprising:

a driving sub-circuit configured to generate current for causing the light emitting element to emit light;

a charging sub-circuit electrically connected to a first power supply line which provides a first voltage signal, a first control signal line which provides a first control signal, and the driving sub-circuit, and configured to provide the first voltage signal to the driving sub-circuit under control of the first control signal;

a writing compensation sub-circuit electrically connected to a reference signal line which provides a reference voltage signal, a data signal line which provides a data signal, a scanning signal line which provides a scanning signal, and the driving sub-circuit, and configured to provide the reference voltage signal and the data signal to the driving sub-circuit under control of the scanning signal; and

a light emitting control sub-circuit electrically connected to the first power supply line, a second control signal line which provides a second control signal, the driving sub-circuit and the light emitting element, and configured to provide the current for causing the light emitting element to emit light to the light emitting element under control of the second control signal.

In an example, the driving sub-circuit comprises a driving transistor and a storage capacitor, wherein the driving transistor is an N-type thin film transistor;

the driving transistor has a gate electrically connected to the charging sub-circuit, a source electrically connected to the light emitting control sub-circuit, and a drain electrically connected to the writing compensation sub-circuit; and

the storage capacitor has a first terminal electrically connected to the gate of the driving transistor, and a second terminal electrically connected to a first terminal of the light emitting element.

In an example, the charging sub-circuit comprises a first transistor having a first electrode electrically connected to the first power supply line, a gate electrically connected to the first control signal line, and a second electrode electrically connected to the first terminal of the storage capacitor.

In an example, the writing compensation sub-circuit comprises a second transistor, a third transistor, and a fourth transistor, wherein the second transistor has a first electrode electrically connected to the gate of the driving transistor, a gate electrically connected to the scanning signal line, and a second electrode electrically connected to the source of the driving transistor;

the third transistor has a first electrode electrically connected to the data signal line, a gate electrically connected to the scanning signal line, and a second electrode electrically connected to the drain of the driving transistor; and

the fourth transistor has a first electrode electrically connected to the reference signal line, a gate electrically connected to the scanning signal line, and a second electrode electrically connected to the first terminal of the light emitting element.

In an example, the light emitting control sub-circuit comprises a fifth transistor and a sixth transistor, wherein

the fifth transistor has a first electrode electrically connected to the first power supply line, a gate electrically connected to the second control signal line, and a second electrode electrically connected to the source of the driving transistor; and

the sixth transistor has a first electrode electrically connected to the drain of the driving transistor, a gate electrically connected to the second control signal line, and a second electrode electrically connected to the first terminal of the light emitting element.

According to another aspect of the present disclosure, there is provided a display panel, comprising:

a plurality of scanning signal lines;

a plurality of data signal lines; and

a plurality of pixel units disposed in a matrix at intersections of the data signal lines and the respective scanning signal lines, and electrically connected to corresponding ones of the data signal lines and corresponding ones of the scanning signal lines, wherein each of the pixel units comprises the pixel driving circuit according to claim 1 and a light emitting element having a first terminal electrically connected to the pixel driving circuit and a second terminal electrically connected to a second voltage.

According to yet another aspect of the present disclosure, there is provided a display apparatus, comprising the display panel according to the embodiments of the present disclosure.

According to a further aspect of the present disclosure, there is provided a pixel driving method applied to the pixel driving circuit according to the embodiments of the present disclosure, the method comprising:

providing, during a first time period, a first control signal of a first level, and a second control signal and a scanning signal of a second level;

providing, during a second time period, a scanning signal of a first level, a first control signal and the second control signal of a second level, a data signal of a first high level and a reference voltage signal of a second high level; and

providing, during a third time period, a second control signal of a first level, and the first control signal and the scanning signal of a second level.

In an example, when the first to sixth transistors are N-type thin film transistors, the first level is a high level, and the second level is a low level.

In an example, when the first to sixth transistors are P-type thin film transistors, the first level is a low level and the second level is a high level.

In an example, the second high level is less than a level of a light emitting threshold voltage of the light emitting element.

### BRIEF DESCRIPTION OF THE DRAWINGS

The above and other purposes, features and advantages of the embodiments of the present disclosure will become more apparent from the following description of the embodiments of the present disclosure in conjunction with the accompanying drawings. It should be illustrated that throughout the accompanying drawings, the same elements are represented by the same or similar reference signs. In the accompanying drawings:

FIG. 1 illustrates a schematic structural diagram of a pixel driving circuit;

FIG. 2 illustrates a timing diagram of an operation of the pixel driving circuit in FIG. 1;

FIG. 3 illustrates a schematic structural diagram of a pixel driving circuit according to an embodiment of the present disclosure;

FIG. 4 illustrates a schematic diagram of a pixel driving circuit according to another embodiment of the present disclosure;

FIG. 5 illustrates a flowchart of a driving method of the pixel driving circuit according to an embodiment of the present disclosure;

FIG. 6 illustrates a driving timing diagram of the pixel driving circuit according to an embodiment of the present disclosure;

FIG. 7A illustrates an equivalent circuit diagram of the pixel driving circuit during a first time period according to an embodiment of the present disclosure;

FIG. 7B illustrates an equivalent circuit diagram of the pixel driving circuit during a second time period according to an embodiment of the present disclosure;

FIG. 7C illustrates an equivalent circuit diagram of the pixel driving circuit during a third time period according to an embodiment of the present disclosure;

FIG. 8 illustrates a schematic structural diagram of a display panel according to an embodiment of the present disclosure; and

FIG. 9 illustrates a schematic structural diagram of a display apparatus according to an embodiment of the present disclosure.

### DETAILED DESCRIPTION

In order to make the purposes, technical solutions and advantages of the embodiments of the present disclosure more apparent, the technical solutions in the embodiments of the present disclosure will be clearly and completely described below in conjunction with the accompanying drawings in the embodiments of the present disclosure. It is apparent that the embodiments described are a part of the embodiments of the present disclosure, instead of all the embodiments. All other embodiments obtained by those of ordinary skill in the art based on the described embodiments of the present disclosure without any creative work are within the protection scope of the present disclosure. In the following description, some specific embodiments are for illustrative purposes only, and are not to be construed as limiting the present disclosure, but merely examples of the embodiments of the present disclosure. Conventional structures or configurations will be omitted when they may cause confusion to the understanding of the present disclosure. It should be illustrated that shapes and sizes of various components in the accompanying drawings do not reflect true sizes and proportions, but merely schematically illustrate contents of the embodiments of the present disclosure.

Technical or scientific terms used in the embodiments of the present disclosure should be of ordinary meaning as understood by those skilled in the art, unless otherwise defined. The terms “first”, “second” or the like used in the embodiments of the present disclosure do not denote any order, quantity, or importance, but are merely used to distinguish different components from each other.

Further, in the description of the embodiments of the present disclosure, the term “electrically connected to” may mean that two components are electrically connected to each other directly, or that two components are electrically connected via one or more other components. In addition, the two components may be electrically connected by wire or wirelessly.

Transistors used in the embodiments of the present disclosure may comprise a switch transistor and a driving transistor, depending on different functions thereof. Both the switch transistor and the driving transistor may be thin film transistors or field effect transistors or other devices having the same characteristics.

A source and a drain of a switch transistor used in the embodiments of the present disclosure are symmetrical, and therefore the source and the drain of the switch transistor are interchangeable. In the embodiments of the present disclosure, one of a source and a drain is referred to as a first electrode, and the other of the source and the drain is referred to as a second electrode. In the following examples, the description will be made by taking a switch transistor being an N-type thin film transistor as an example. It may be understood by those skilled in the art that the embodiments of the present disclosure are obviously applicable to a case where the switch transistor is a P-type thin film transistor.

Further, in the description of the embodiments of the present disclosure, the term “first level” refers to a level for causing a specific transistor to be turned on, and the term “second level” refers to a level for causing a specific transistor to be turned off. The “first level” and “second level” are only used to distinguish amplitudes of two levels from each other. For example, hereinafter, in a case where first to sixth transistors are exemplarily N-type thin film transistors, the description will be made by taking the “first level” being a high level and the “second level” being a low level as an example. Similarly, in a case where the first to sixth transistors are exemplarily P-type thin film transistors, the “first level” is a low level, and the “second level” is a high level. It may be understood by those skilled in the art that the present disclosure is not limited thereto. It should also be illustrated that, for a specific transistor herein, the “high level” and the “low level” are only used to distinguish amplitudes of levels for enabling the transistor to be turned on and turned off, and do not intend to mean that values of the levels are higher than a certain threshold or lower than a certain threshold.

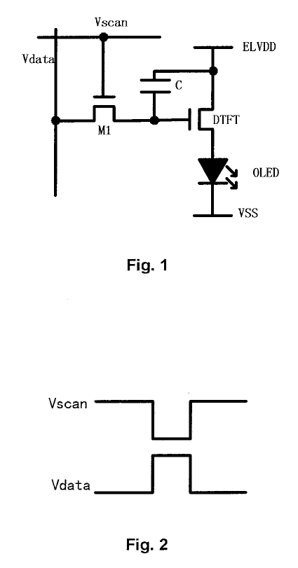

FIG. 1 illustrates a schematic structural diagram of a pixel driving circuit. FIG. 2 illustrates a timing diagram of an operation of the pixel driving circuit shown in FIG. 1, which illustrates a timing relationship of a scanning signal provided by a scanning line and a data signal provided by a data line. As shown in FIG. 1, the pixel driving circuit 10 is a 2T1C pixel driving circuit. The pixel driving circuit 10 comprises a driving transistor DTFT, a switch transistor M1, and a storage capacitor C. In an example of FIG. 1, the driving transistor DTFT and the switch transistor M1 are both P-type thin film transistors. When a certain row is gated (that is, scanned) by a scanning signal line, a scanning signal Vscan is a low level signal, the switch transistor M1 is turned on, and a data signal Vdata is written into the storage capacitor C. After the row is scanned completely, Vscan becomes a high level signal, the switch transistor M1 is turned off, and the DTFT is driven by a gate voltage stored on the storage capacitor C to generate current to drive an OLED, thereby ensuring that the OLED continuously emits light in one frame of display. A current formula for the driving thin film transistor DTFT is as follows:

I_{oled}=K(Vgs−Vth)²,

where K is a parameter related to a process and design of the driving transistor DTFT, and is a constant once the driving transistor DTFT is manufactured completely, Vgs is a gate-source voltage of the driving thin film transistor, and Vth is a threshold voltage of the driving transistor. Since Vgs=Vdata-ELVDD, I_{oled}=K(Vdata−ELVDD−Vth)².

It may be seen from the above current formula for the driving transistor DTFT that in the OLED pixel driving circuit in FIG. 1, there is a quadratic relationship among current flowing through the driving transistor DTFT, Vth of the driving transistor DTFT and a power supply voltage VDD connected to an S terminal of the DTFT. Therefore, as long as Vth of the driving transistor DTFT has a difference of more than 0.1V between individual pixel units, it may cause a significant deviation of the driving current. Thereby, it may result in a difference in brightness of light emitting elements and an afterimage appearing on a display picture. Meanwhile, since OLED pixels are driven by current, as the OLEDs are lit up, there is current on an ELVDD in a lit-up pixel unit for lighting up the pixel unit, and due to the presence of resistance of an ELVDD lead, the ELVDD has a difference in voltage between individual pixel units along the ELVDD lead. Thereby, it may cause a gradual change in brightness of pixel points along the ELVDD lead, which is the so-called ELVDD lead resistance voltage drop. Therefore, it should be aware of issues of reducing a voltage fluctuation of the ELVDD and reducing the ELVDD lead resistance voltage drop in a display panel.

To this end, in the pixel driving circuit 10 shown in, for example, FIG. 1, a P-type thin film transistor is generally used as the driving transistor DTFT. This is because as compared with a source of a driving transistor DTFT implemented using an N-type thin film transistor being electrically connected to the power supply voltage ELVDD, when a drain of a driving transistor DTFT implemented using a P-type transistor is electrically connected to the ELVDD, the ELVDD applied to the driving transistor DTFT is relatively more stable. When the storage capacitor C connected between a gate and a source of the DTFT is charged, a voltage at one terminal of the storage capacitor C is Vdata, and a voltage at the other terminal of the storage capacitor C is ELVDD. Therefore, there is a relatively more stable charging voltage for the storage capacitor C. However, as an area of the OLED display panel increases, problems such as a slow response speed of the pixel driving circuit and an afterimage appearing on a display picture due to a voltage difference etc. occur.

The inventors have discovered that a conductive layer which is obtained by ionization of a semiconductor interface by a PMOS device has holes, that is, conductive carriers are holes. Since the holes has mobility much lower than that of electrons, the P-type driving transistor has a slow response speed. Further, in a case where a negative voltage is applied to the P-type driving transistor so that the P-type driving transistor is turned on for a long time, a large amount of holes are accumulated in an interface between a semiconductor and an oxide layer all the time, and the holes may be tunneled into traps in the interface of the oxide layer. As more and more holes are tunneled into the traps in the oxide layer, the threshold voltage Vth of the DTFT may drift. Since the holes have low mobility, the holes falling in the traps are difficult to be pulled out of the traps even if a positive voltage is applied. Since Vth of a pixel point which is stressed for a long time is different from that of another pixel point without being stressed, there is a difference in brightness of the two pixel points, which causes an image which is stressed for a long time, that is, an afterimage, appearing on a display picture of a display screen.

Therefore, if the driving transistor is implemented as an NMOS transistor, since the carriers are electrons which are more easily to be pulled out of traps if they fall into the traps, it is more favorable for recovery of Vth, and thereby the display picture may be rapidly recovered from the above-mentioned afterimage. The embodiments of the present disclosure provide a pixel driving circuit structure using an N-type driving transistor, which may realize a stable ELVDD and a small ELVDD lead resistance voltage drop in a display panel even if a source of the N-type driving transistor is used to be electrically connected to the ELVDD, thereby improving a display effect of the display panel.

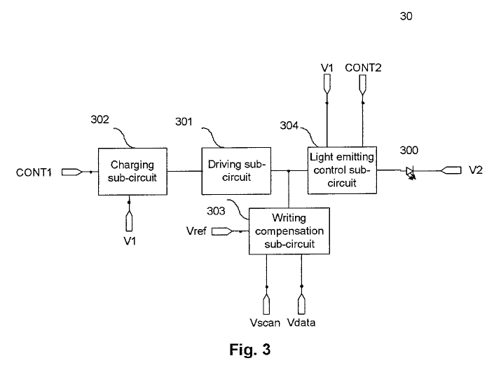

FIG. 3 illustrates a schematic structural diagram of a pixel driving circuit 30 according to an embodiment of the present disclosure. The pixel driving circuit 30 is configured to drive a light emitting element 300. The light emitting element 300 is shown in FIG. 3 as a light emitting diode OLED. As shown in FIG. 3, the pixel driving circuit 30 according to an embodiment of the present disclosure may comprise a driving sub-circuit 301 configured to generate current for causing the light emitting element 300 to emit light. The pixel driving circuit 30 may further comprise a charging sub-circuit 302 electrically connected to a first power supply line which provides a first voltage signal V1, a first control signal line which provides a first control signal CONT1, and the driving sub-circuit 301. The charging sub-circuit 302 is configured to charge the driving sub-circuit 301 using the first voltage signal V1 under control of the first control signal CONT1. The pixel driving circuit 30 may further comprise a writing compensation sub-circuit 303 electrically connected to a reference signal line which provides a reference voltage signal Vref, a data signal line which provides a data signal Vdata, a scanning signal line which provides a scanning signal Vscan, and the driving sub-circuit 301, and configured to write the reference voltage signal Vref and the data signal Vdata into the driving sub-circuit 301 under control of the scanning signal Vscan. The pixel driving circuit 30 may further comprise a light emitting control sub-circuit 304 electrically connected to the first power supply line, a second control signal line which provides a second control signal CONT2, the driving sub-circuit, and the light emitting element 300. The light emitting control sub-circuit 304 is configured to provide the current for causing the light emitting element 300 to emit light to the light emitting element 300 under control of the second control signal CONT2, to control the driving sub-circuit 301 to drive the light emitting element 300 to emit light.

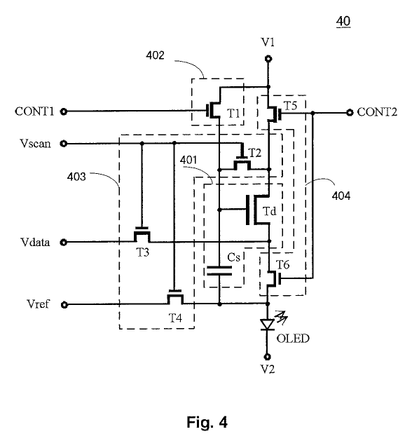

FIG. 4 illustrates a schematic structural diagram of a pixel driving circuit according to another embodiment of the present disclosure. As shown in FIG. 4, a driving sub-circuit 401 may comprise a driving transistor Td and a storage capacitor Cs. According to an embodiment of the present disclosure, the driving transistor Td is an N-type thin film transistor. The driving transistor Td has a gate electrically connected to a charging sub-circuit 402, a source electrically connected to a light emitting control sub-circuit 404, and a drain electrically connected to a writing compensation sub-circuit 403. The storage capacitor Cs has a first terminal electrically connected to the gate of the driving transistor Td, and a second terminal electrically connected to a first terminal of a light emitting element.

As shown in FIG. 4, the charging sub-circuit 402 may comprise a first transistor T1. The first transistor T1 has a first electrode electrically connected to a first power supply line which provides a first voltage signal V1, a control electrode, i.e., a gate, electrically connected to a first control signal line which provides a first control signal CONT1, and a second electrode electrically connected to the first terminal of the storage capacitor Cs.

The writing compensation sub-circuit 403 may comprise a second transistor T2, a third transistor T3, and a fourth transistor T4. The second transistor T2 has a first electrode electrically connected to the gate of the driving transistor Td, a control electrode, i.e., a gate, electrically connected to a scanning signal line which provides a scanning signal Vscan, and a second electrode electrically connected to the source of the driving transistor Td. The third transistor T3 has a first electrode electrically connected to a data signal line which provides a data signal Vdata, a control electrode, i.e., a gate, electrically connected to the scanning signal line which provides the scanning signal Vscan, and a second electrode electrically connected to the drain of the driving transistor Td. The fourth transistor T4 has a first electrode electrically connected to a reference signal line which provides a reference signal Vref, a control electrode, i.e., a gate, electrically connected to the scanning signal line, and a second electrode electrically connected to the first terminal of the light emitting element.

The light emitting control sub-circuit 404 may comprise a fifth transistor T5 and a sixth transistor T6. The fifth transistor T5 has a first electrode electrically connected to the first power supply line, a control electrode, i.e., a gate, electrically connected to a second control signal line which provides a second control signal CONT2, and a second electrode electrically connected to the source of the driving transistor Td. The sixth transistor T6 has a first electrode electrically connected to the drain of the driving transistor Td, a control electrode, i.e., a gate, electrically connected to the second control signal line, and a second electrode electrically connected to the first terminal of the light emitting element. For example, the second control signal may also be referred to as a “light emitting control signal.”

According to an embodiment of the present disclosure, as shown in FIG. 4, a second terminal of the light emitting element OLED may be electrically connected to a second voltage V2. It may be understood by those skilled in the art that the second terminal of the light emitting element OLED may be electrically connected to a second power supply line which provides the second voltage signal V2, or may also be grounded, that is, the second voltage V2 may be at a potential of zero.

According to an embodiment of the present disclosure, although the first to sixth transistors T1 to T6 are illustrated in FIG. 4 as N-type thin film transistors, the first to sixth transistors T1 to T6 may also be P-type thin film transistors. It may be understood by those skilled in the art that in a case where the driving transistor Td is an N-type thin film transistor, if the first to sixth transistors T1 to T6 are implemented as N-type thin film transistors, it is more advantageous for simplifying the process.

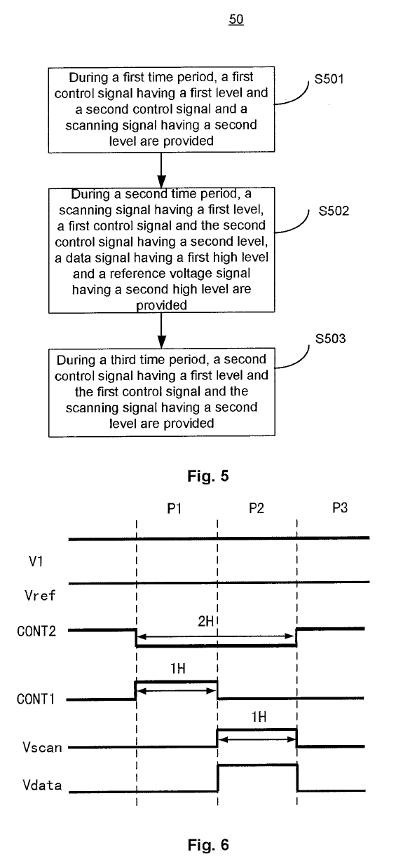

According to an embodiment of the present disclosure, there is further provided a driving method of the pixel driving circuit. FIG. 5 illustrates a flowchart of a driving method of the pixel driving circuit according to an embodiment of the present disclosure. As shown in FIG. 5, the driving method 50 of the pixel driving circuit according to an embodiment of the present disclosure may comprise the following steps. It should be illustrated that serial numbers of the respective steps in the following method are only used as a representation of the steps for convenience of description, and should not be regarded as indicating an execution order of the respective steps. This method needs not to be performed exactly in an order as shown, unless explicitly stated.

In step S501, during a first time period, a first control signal of a first level and a second control signal and a scanning signal of a second level are provided.

Thereby, the storage capacitor is charged by the charging sub-circuit under control of the first control signal.

In step S502, during a second time period, a scanning signal of a first level, a first control signal and the second control signal of a second level, a data signal of a first high level and a reference voltage signal of a second high level are provided.

Thereby, the storage capacitor is discharged to the data signal line via the driving transistor under control of the scanning signal, until the data signal, the reference voltage signal, and a threshold voltage of the driving transistor are written into the storage capacitor.

Here, since the driving transistor Td is an N-type transistor, the data signal and the reference voltage signal are set to provide the high levels to the driving transistor Td during the second time period, and the first high level and the second high level are used to indicate that the data signal and the reference voltage signal have different levels; otherwise, driving current of the OLED as described below will be equal to zero. As an example, the first high level and the second high level are schematically illustrated in FIG. 6 of the present disclosure.

In step S503, during a third time period, a second control signal of a first level and the first control signal and the scanning signal of a second level are provided.

Thereby, the data signal, the reference signal and the threshold voltage value maintained on the storage capacitor are applied to the gate terminal and the source terminal of the driving transistor under control of the second control signal, so that the light emitting element is driven by the driving transistor to emit light.

In the embodiment shown in FIG. 4, the first to sixth transistors T1 to T6 are shown as N-type thin film transistors, so that when the method 50 is applied to the exemplary pixel driving circuit of FIG. 4, the first level is a high level, and the second level is a low level. Similarly, when the first to sixth transistors T1 to T6 are shown as P-type thin film transistors, the first level is a high level and the second level is a low level.

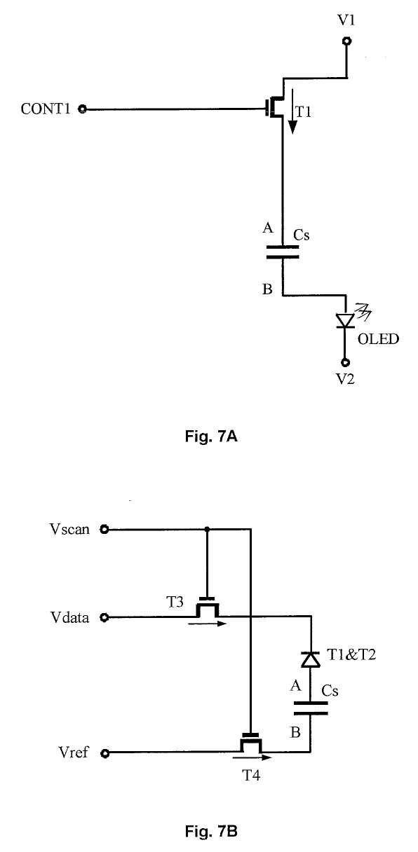

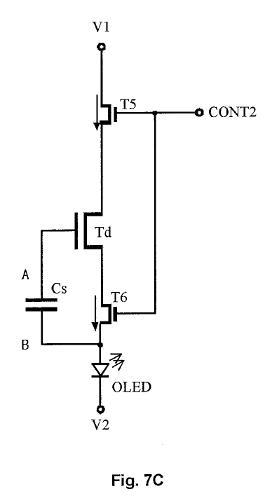

FIG. 6 illustrates a driving timing diagram of the pixel driving circuit according to an embodiment of the present disclosure, FIG. 7A illustrates an equivalent circuit diagram of the pixel driving circuit during a first time period according to an embodiment of the present disclosure, FIG. 7B illustrates an equivalent circuit diagram of the pixel driving circuit during a second time period according to an embodiment of the present disclosure, and FIG. 7C illustrates an equivalent circuit diagram of the pixel driving circuit during a third time period according to an embodiment of the present disclosure. Next, an operation of the pixel driving circuit according to an embodiment of the present disclosure will be described in detail with reference to FIGS. 5, 6, 7A, 7B, and 7C.

As shown in FIG. 6, during a first time period P1, the first voltage signal V1 is at a high level, the first control signal CONT1 is at a high level, and the second control signal CONT2 and the scanning signal Vscan are at a low level. Under control of the first control signal CONT1, the first transistor T1 is turned on, the second to sixth transistors T2 to T6 are turned off, and the driving transistor Td is turned on. FIG. 7A illustrates an equivalent circuit diagram of the pixel driving circuit during the first time period P1 according to an embodiment of the present disclosure. As shown in FIG. 7A, the first transistor T1 is turned on, and the first voltage signal V1, the first transistor T1, the storage capacitor Cs, the light emitting element OLED, and the second voltage V2 constitute a charging loop. The storage capacitor Cs is charged using the first voltage signal V1 via the first transistor T1. During the first time period P1, a voltage at the first terminal (shown as point A in the figure, that is, one terminal electrically connected to the gate of the driving transistor Td) of the storage capacitor Cs is at a high level V1, that is, V_{A}=V1, to prepare for writing Vth into the storage capacitor Cs, wherein Vth is the threshold voltage of the driving transistor Td. At this time, a voltage at the second terminal (shown as point B in the figure, that is, one terminal electrically connected to the first terminal of the light emitting element OLED) of the storage capacitor Cs is maintained as V_{B}=(V2+|Voled|), wherein Voled is a light emitting threshold voltage of the light emitting element OLED.

According to an embodiment of the present disclosure, a scanning signal for a previous row of pixel units of a current row of pixel units is used as the first control signal CONT1. That is, a scanning signal for an N^{th} row of pixel driving circuits is Vscan(n), and a scanning signal Vscan(n−1) for an (N−1)^{th} row of pixel driving circuits may be used as a first control signal CONT1 for the N^{th} row of pixel driving circuits, wherein N is an integer greater than 1.

Next, during a second time period P2, the first voltage signal V1 is at a high level, the first control signal CONT1 and the second control signal CONT2 are at a low level, and thereby the first transistor T1, the fifth transistor T5, and the sixth transistor T6 are turned off. The scanning signal Vscan is at a high level, and under control of the scanning signal Vscan, the second transistor T2, the third transistor T3, and the fourth transistor T4 are turned on. Further, since the voltage V_{A} at the first terminal of the storage capacitor Cs which is electrically connected to the gate of the driving transistor Td is at a high level V1, the driving transistor Td continues to be turned on.

FIG. 7B illustrates an equivalent circuit diagram of the pixel driving circuit during the second time period P2 according to an embodiment of the present disclosure. As shown in FIG. 7B, since the turned-on second transistor T2 electrically connects the drain and the gate of the driving transistor Td at this time, the second transistor T2 and the driving transistor Td substantially constitute a diode. A forward turn-on voltage of the diode is the threshold voltage Vth of the driving transistor. Since the storage capacitor Cs is charged during the first time period P1, the voltage V_{A} at the point A is the first voltage V1. At this time, the point A of the storage capacitor Cs is discharged to the data signal line via the diode formed by the second transistor T2 and the driving transistor Td and the turned-on third transistor T3. When equilibrium is reached, the voltage at the point A is V_{A}=Vdata+|Vth|. On the other hand, since the fourth transistor T4 is turned on, the point B is charged using the reference voltage Vref via the fourth transistor T4, so that the voltage at the point B is V_{B}=Vref. Thereby, a voltage across the storage capacitor Cs is V_{Cs}=V_{A}−V_{B}=Vdata+|Vth|−Vref.

According to an embodiment of the present disclosure, the reference voltage signal Vref may be set to be less than (V2+Voled), so that the light emitting element OLED does not emit light during the second time period P2. It may be understood by those skilled in the art that when V2 is at a ground potential, amplitude of the reference voltage signal Vref (i.e., the second high level as described above) may be less than amplitude of the light emitting threshold voltage Voled of the light emitting element OLED.

Next, during a third time period P3, the first voltage signal V1 is at a high level, the first control signal CONT1 and the scanning signal Vscan are at a low level, and thereby the first transistor T1, the second transistor T2, the third transistor T3 and the fourth transistor T4 are turned off. The second control signal CONT2 is at a high level, and under control of the second control signal CONT2 at a high level, the fifth transistor T5 and the sixth transistor T6 are turned on.

FIG. 7C illustrates an equivalent circuit diagram of the pixel driving circuit during the third time period P3 according to an embodiment of the present disclosure. As shown in FIG. 7C, at this time, the voltage V_{B} at the point B of the storage capacitor Cs is clamped to (V2+Voled), the voltage across the storage capacitor Cs is maintained as V_{Cs}=Vdata+|Vth|−Vref, and the voltage at the point A is V_{A}=Vdata+|Vth|−Vref+V2+Voled. Therefore, a source-gate voltage of the driving transistor Td is Vgs=Vdata+|Vth|−Vref at this time.

It may be seen from I_{DS}=K(V_{gs}−Vth)² that

the current flowing through the driving transistor Td is I_{DS}=K(Vdata+Vth−Vref−Vth)²=K(Vdata−Vref)²,

where Vgs is the gate-source voltage of the driving transistor Td, and K is a parameter related to a process and design of the driving transistor DTFT, and is constant once the driving transistor DTFT is manufactured completely, as described above with reference to FIG. 1.

It may be seen that the above current I_{DS} is independent of both the voltage V1 at the source of the driving transistor Td and the threshold voltage Vth of the driving transistor Td. Therefore, the pixel driving circuit according to the embodiment of the present disclosure may compensate for the threshold voltage Vth of the driving transistor Td and the voltage V1 at the source of the driving transistor Td.

According to an embodiment of the present disclosure, when one of the first control signal CONT1 and the scanning signal Vscan is at a first level, the second control signal CONT2 is at a second level different from the first level. For example, duration of 1H in FIG. 6 may be a scanning time for one row of pixel units.

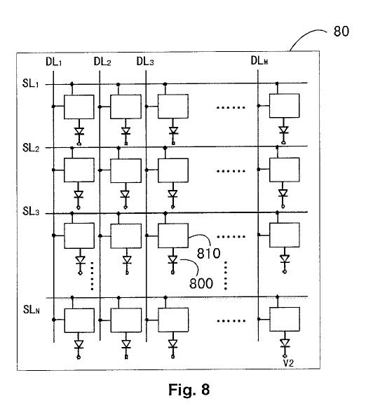

According to an embodiment of the present disclosure, there is provided a display panel. FIG. 8 illustrates a schematic structural diagram of a display panel according to an embodiment of the present disclosure. As shown in FIG. 8, the display panel 80 according to the embodiment of the present disclosure may comprise a plurality of scanning signal lines S_{L1} to SL_{N}; a plurality of data signal lines D_{L1} to DL_{M}, where M and N are positive integers; and a plurality of pixel units disposed in a matrix at intersections of the data signal lines and the respective scanning signal lines, and electrically connected to corresponding ones of the data signal line and corresponding ones of the scanning signal lines, wherein each of the pixel units comprises a pixel driving circuit 810 according to the embodiments of the present disclosure which is connected to a corresponding one of the data signal lines and a corresponding one of the scanning signal lines, and a light emitting element 800. The light emitting element 800 may have a first terminal electrically connected to the pixel driving circuit 810, and a second terminal electrically connected to a second voltage V2.

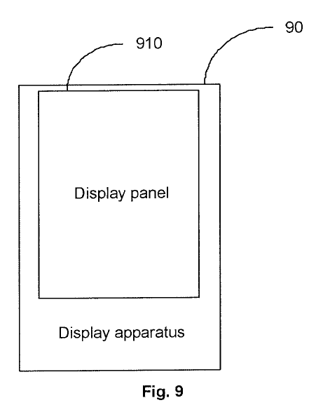

According to an embodiment of the present disclosure, there is provided a display apparatus. FIG. 9 illustrates a schematic structural diagram of a display apparatus 90 according to an embodiment of the present disclosure. As shown in FIG. 9, the display apparatus 90 according to the embodiment of the present disclosure may comprise a display panel 910 according to the embodiment of the present disclosure. The display apparatus 90 according to the embodiment of the present disclosure may be any product or component having a display function, such as an electronic paper, a mobile phone, a tablet computer, a television, a display, a notebook computer, a digital photo frame, a navigator, etc.

It should be illustrated that, in the above description, the technical solutions according to the embodiments of the present disclosure are illustrated by way of example only, but should not be construed as limiting the embodiments of the present disclosure to the above steps and structures. Wherever possible, the steps and structures may be adjusted and omitted as needed. Therefore, certain steps and elements are not essential elements for implementing the general inventive concept of the embodiments of the present disclosure.

The present disclosure has been described hereto in connection with the preferred embodiments. It should be understood that various other changes, substitutions and additions may be made by those skilled in the art without departing from the spirit and scope of the embodiments of the present disclosure. Therefore, the scope of the embodiments of the present disclosure is not limited to the specific embodiments described above, but should be defined by the appended claims.

I/We claim:

1. A pixel driving circuit configured to drive a light emitting element to emit light, the pixel driving circuit comprising:
a driving sub-circuit configured to generate current for causing the light emitting element to emit light;
a charging sub-circuit electrically connected to a first power supply line which provides a first voltage signal, a first control signal line which provides a first control signal, and the driving sub-circuit, and configured to provide the first voltage signal to the driving sub-circuit under control of the first control signal;
a writing compensation sub-circuit electrically connected to a reference signal line which provides a reference voltage signal, a data signal line which provides a data signal, a scanning signal line which provides a scanning signal, and the driving sub-circuit, and configured to provide the reference voltage signal and the data signal to the driving sub-circuit under control of the scanning signal; and
a light emitting control sub-circuit electrically connected to the first power supply line, a second control signal line which provides a second control signal, the driving sub-circuit and the light emitting element, and configured to provide the current for causing the light emitting element to emit light to the light emitting element under control of the second control signal.

2. The pixel driving circuit according to claim 1, wherein the driving sub-circuit comprises a driving transistor and a storage capacitor, wherein the driving transistor is an N-type thin film transistor;
the driving transistor has a gate electrically connected to the charging sub-circuit, a source electrically connected to the light emitting control sub-circuit, and a drain electrically connected to the writing compensation sub-circuit; and
the storage capacitor has a first terminal electrically connected to the gate of the driving transistor, and a second terminal electrically connected to a first terminal of the light emitting element.

3. The pixel driving circuit according to claim 2, wherein the charging sub-circuit comprises a first transistor having a first electrode electrically connected to the first power supply line, a gate electrically connected to the first control signal line, and a second electrode electrically connected to the first terminal of the storage capacitor.

4. The pixel driving circuit according to claim 2, wherein the writing compensation sub-circuit comprises a second transistor, a third transistor, and a fourth transistor, wherein
the second transistor has a first electrode electrically connected to the gate of the driving transistor, a gate electrically connected to the scanning signal line, and a second electrode electrically connected to the source of the driving transistor;
the third transistor has a first electrode electrically connected to the data signal line, a gate electrically connected to the scanning signal line, and a second electrode electrically connected to the drain of the driving transistor; and
the fourth transistor has a first electrode electrically connected to the reference signal line, a gate electrically connected to the scanning signal line, and a second electrode electrically connected to the first terminal of the light emitting element.

5. The pixel driving circuit according to claim 2, wherein the light emitting control sub-circuit comprises a fifth transistor and a sixth transistor, wherein
the fifth transistor has a first electrode electrically connected to the first power supply line, a gate electrically connected to the second control signal line, and a second electrode electrically connected to the source of the driving transistor; and
the sixth transistor has a first electrode electrically connected to the drain of the driving transistor, a gate electrically connected to the second control signal line, and a second electrode electrically connected to the first terminal of the light emitting element.

6. A display panel, comprising:
a plurality of scanning signal lines;
a plurality of data signal lines; and
a plurality of pixel units disposed in a matrix at intersections of the data signal lines and the respective scanning signal lines, and electrically connected to corresponding ones of the data signal lines and corresponding ones of the scanning signal lines, wherein each of the pixel units comprises the pixel driving circuit according to claim 1 and a light emitting element having a first terminal electrically connected to the pixel driving circuit and a second terminal electrically connected to a second voltage.

7. A display apparatus, comprising the display panel according to claim 6.

8. A pixel driving method applied to the pixel driving circuit according to claim 1, the method comprising:
providing, during a first time period, a first control signal of a first level, and a second control signal and a scanning signal of a second level;
providing, during a second time period, a scanning signal of a first level, a first control signal and the second control signal of a second level, a data signal of a first high level and a reference voltage signal of a second high level; and
providing, during a third time period, a second control signal of a first level, and the first control signal and the scanning signal of a second level.

9. The pixel driving method according to claim 8, wherein when the first to sixth transistors are N-type thin film transistors, the first level is a high level, and the second level is a low level.

10. The pixel driving method according to claim 8, wherein when the first to sixth transistors are P-type thin film transistors, the first level is a low level and the second level is a high level.

11. The pixel driving method according to claim 8, wherein the second high level is less than a level of a light emitting threshold voltage of the light emitting element.
